(19) United States
(12) Patent Application Publication
(10) Pub. No.: US 2025/0373183 A1
(43) Pub. Date: Dec. 4, 2025

(54) ELECTROMAGNETIC TRANSIENT MODELING METHOD AND SYSTEM FOR HIGH-EFFICIENCY SYNCHRONOUS MACHINE, AND DEVICE

(71) Applicants: ELECTRIC POWER RESEARCH INSTITUTE, CHINA SOUTHERN POWER GRID, Guangzhou, Guangdong (CN); CHINA SOUTHERN POWER GRID COMPANY LIMITED, Guangzhou, Guangdong (CN)

(72) Inventors: Yinsheng SU, Guangzhou, Guangdong (CN); Xiaoshan WU, Guangzhou, Guangdong (CN); Sijia TU, Guangzhou, Guangdong (CN); Haicheng YAO, Guangzhou, Guangdong (CN); Bao LI, Guangzhou, Guangdong (CN); Ligang ZHAO, Guangzhou, Guangdong (CN); Tinghui ZHOU, Guangzhou, Guangdong (CN); Qin GAO, Guangzhou, Guangdong (CN); Guanbiao HUANG, Guangzhou, Guangdong (CN); Hongyue ZHEN, Guangzhou, Guangdong (CN); Yuan XU, Guangzhou, Guangdong (CN); Changxiang WANG, Guangzhou, Guangdong (CN); Zhenyu MAO, Guangzhou, Guangdong (CN); Xuepeng MOU, Guangzhou, Guangdong (CN)

(73) Assignees: ELECTRIC POWER RESEARCH INSTITUTE, CHINA SOUTHERN POWER GRID, Guangzhou, Guangdong (CN); CHINA SOUTHERN POWER GRID COMPANY LIMITED, Guangzhou, Guangdong (CN)

(21) Appl. No.: 18/874,625

(22) PCT Filed: Sep. 29, 2022
(86) PCT No.: PCT/CN2022/122582

§ 371 Date: Dec. 13, 2024

(30) Foreign Application Priority Data
Jun. 15, 2022 (CN) 202210674165.1

(51) Int. Cl. H02P 6/34

(52) U.S. Cl. CPC H02P 6/34

(57) ABSTRACT

An electromagnetic transient modeling method and system for a high-efficiency synchronous machine, and, a device. The method comprises: predicting, of a synchronous machine, a first rotor angular velocity, a first rotor angle, and a first current q component of and a first current d component of an armature current, establishing a first Norton circuit for simulating the synchronous machine, and solving at the same time a second Norton circuit after equivalent transformation and a network conductance matrix so as to obtain a three-phase voltage of a synchronous machine port; according to the three-phase voltage, obtaining a second current q component, a second current d component, a second rotor angular velocity and a second rotor angle; and by means of error-controlled iterative solving, determining an electromagnetic transient simulation calculation result of the synchronous machine.

The present application claims priority to Chinese Patent Application No. 202210674165.1, titled “METHOD AND SYSTEM FOR MODELLING ELECTROMAGNETIC TRANSIENTS OF HIGH-EFFICIENCY SYNCHRONOUS MOTOR, AND DEVICE”, filed on Jun. 15, 2022, with the China National Intellectual Property Administration, which is incorporated herein by reference in its entirety.

### FIELD

The present disclosure relates to the technical field of electromagnetic transients, and in particular to a method and a system for modelling electromagnetic transients of a high-efficiency synchronous motor, and a device.

### BACKGROUND

Rapid promotion and application of new energy and direct-current transmission, especially flexible direct-current transmission, engenders a new trend of performing simulation on electromagnetic transients of large power grids. Experts are dedicating their research to a significant improvement of efficiency of simulating electromagnetic transient models and algorithms while ensuring accuracy.

Rotating motor is an important electric component in electromagnetic transient simulation. Modeling and simulating the rotating motor with high efficiency is crucial for accuracy and efficiency of simulating electromagnetic transients of an integral power system, especially one with many new energy sources. In conventional software for electromagnetic transient simulation, the dq0 model is widely applied as rotating motor model for ensuring simulation efficiency. The dq0 model adopts a predictor-corrector method when handing electric quantities, and hence its accumulated error would result in inaccuracy in case of a large step size in simulation.

### SUMMARY

A method and a system for modelling electromagnetic transients of a high-efficiency synchronous motor, and a device, are provided according to embodiments of the present disclosure. Addressed is a technical issue that utilization of dq0 models as rotating motor models in conventional software for electromagnetic transient simulation results in accumulated error and inaccuracy in case of a large step size in simulation.

Following technical solutions are thus provided according to embodiments of the present disclosure.

A method for modeling electromagnetic transients of a high-efficiency synchronous motor is provided according to an embodiment of the present disclosure. The method comprises: step S1, predicting a first rotor angular velocity, a first rotor angle, a first quadrature-axis component (q-component) of an armature current, and a first direct-axis component (d-component) of the armature current, of a synchronous motor at a given moment through linear extrapolation;

step S2, determining, according to the first q-component and the first d-component, a first equation of Norton equivalent circuit for simulating the synchronous motor, and transforming the first equation of Norton equivalent circuit expressed in a direct-quadrature-zero (dq0) reference frame into a second equation of Norton equivalent circuit expressed in a three-phase (abc) reference frame through coordinate transformation; step S3, determining an equivalent conductance matrix, which is an inverse of an equivalent resistance matrix in the second equation of Norton equivalent circuit, and solving a network conductance matrix, through substituting the determined equivalent conductance matrix into the network conductance matrix, to obtain three phase-voltages at ports of the synchronous motor; step S4, determining, according to the three phase-voltages, a second q-component and a second d-component of the armature current of the synchronous motor, a rotor current of the synchronous motor, and a d-component and a q-component of a stator magnetic flux linkage of the synchronous motor; step S5, solving a mechanical system equation, through substituting the second q-component, the second d-component, the d-component of the stator magnetic flux linkage, and the q-component of the stator magnetic flux linkage into the mechanical system equation, to obtain a second rotor angular velocity and a second rotor angle of the synchronous motor; and step S6, obtaining absolute differences between the second q-component and the first q-component, between the second d-component and the first d-component, between the second rotor angular velocity and the first rotor angular velocity, and between the second rotor angle and the first rotor angle, respectively, and returning to the step S1 for a next time step in response to each of the absolute differences being smaller than a respective difference threshold of said absolute difference.

In an embodiment, the method further comprises: returning to the step S4 in response to any of the absolute differences being not smaller than the respective difference threshold of said absolute difference.

In an embodiment, the mechanical system equation is:

$${T}_{gen} = \frac{p}{2} ( {λ}_{d} {i}_{s 2}^{q} - {λ}_{q} {i}_{s 2}^{d} )$$

$$ω = \frac{d θ}{dt}$$

$$J \frac{d ω}{dt} + D ω = T - {T}_{gen} ,$$

where p represents a number of poles in the synchronous motor, λ_{q} represents the q-component of the stator magnetic flux linkage, λ_{d} represents the d-component of the stator magnetic flux linkage,

$${i}_{s 2}^{d}$$

represents the second d-component,

$${i}_{s 2}^{q}$$

represents the second q-component, J represents rotational inertia of the synchronous motor, D represents a coefficient of viscosity and air-damping of the synchronous motor in air, T represents a mechanical torque of the synchronous motor, ω represents the second rotor angular velocity, θ represents the second rotor angle, and t represents time in simulation.

In an embodiment, the step S2 comprises: obtaining a stator-rotor voltage equation of the synchronous motor, and discretizing the stator-rotor voltage equation through an implicit trapezoidal rule to obtain a first transformation equation; performing Park transformation on the first transformation equation, eliminating a rotor variable in the first transformation equation, and using average resistance for a direct-axis and a quadrature-axis, to obtain a Thevenin equation for a stator; transforming the Thevenin equation for the stator to the first equation of Norton equivalent circuit; and transforming the first equation of Norton equivalent circuit expressed in the dq0 reference frame into the second equation of Norton equivalent circuit expressed in the abc reference frame through phasor coordinate transformation.

The first equation of Norton equivalent circuit is as follows.

$${i}_{d , source} = \frac{{e}_{d , mod}}{{R}_{ave}} ; {i}_{q , source} = \frac{{e}_{q , mod}}{{R}_{ave}} ; {i}_{0 , source} = \frac{{e}_{0}}{{R}_{0}}$$

$${R}_{ave} = ( {R}_{d} + {R}_{q} ) / 2 ; {e}_{d , mod} = {e}_{d} - \frac{{R}_{d} - {R}_{q}}{2} {i}_{s 1}^{d} , {e}_{q , mod} = {e}_{q} - \frac{{R}_{d} - {R}_{q}}{2} {i}_{s 1}^{q}$$

The phasor coordinate transformation formula is as follows.

$$[ \begin{matrix}{i}_{a , source} \\ {i}_{b , source} \\ {i}_{c , source}\end{matrix} ] = \frac{\sqrt{2}}{\sqrt{3}} [ \begin{matrix}cos {θ}_{1} & sin {θ}_{1} & \frac{1}{\sqrt{2}} \\ cos ( {θ}_{1} - 120 ° ) & sin ( {θ}_{1} - 120 ° ) & \frac{1}{\sqrt{2}} \\ cos ( {θ}_{1} + 120 ° ) & sin ( {θ}_{1} + 120 ° ) & \frac{1}{\sqrt{2}}\end{matrix} ] [ \begin{matrix}{i}_{d , source} \\ {i}_{q , source} \\ {i}_{0 , source}\end{matrix} ]$$

$${i}_{s 1}^{d}$$

represents the second d-component,

$${i}_{s 1}^{q}$$

represents the first q-component, R_{d}, R_{q} and R₀ are resistance parameters in a resistance matrix in the Thevenin equation, e_{d}, e_{q} and e₀ are voltage parameters in a voltage-source matrix in the Thevenin equation, i_{d, source} represents a first current of a direct-axis in first equation of Norton equivalent circuit, i_{q, source} represents a second current of a quadrature-axis in the first equation of Norton equivalent circuit, i_{0, source} represents a third current of a zero component in the first equation of Norton equivalent circuit, θ₁ represents a first rotor angle, i_{a, source} represents a first current of an a-phase current source in the second equation of Norton equivalent circuit, i_{b, source} represents a second current of a b-phase current source in the second equation of Norton equivalent circuit, and i_{c, source} represents a third current of a c-phase current source in a second equation of Norton equivalent circuit.

In an embodiment, the step S4 comprises: performing Park transformation on the three phase-voltages to obtain voltage components of a direct-axis, a quadrature-axis, and a zero sequence; calculating the second q-component and the second d-component according to matrix parameters of a Thevenin equation for the stator and the voltage components through an armature-current calculation equation; calculating the rotor current according to parameters of the synchronous motor, the voltage components, the second q-component, and the second d-component through a rotor-current calculation equation; calculating the d-component and the q-component of the stator magnetic flux linkage according to the parameters of the synchronous motor, the second q-component, the second d-component, and the rotor current, through a stator-flux-linkage-component calculation equation.

The Park transformation is implemented through a following equation.

$$[ \begin{matrix}{v}_{d} \\ {v}_{q} \\ {v}_{0}\end{matrix} ] = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ] [ \begin{matrix}{v}_{a} \\ {v}_{b} \\ {v}_{c}\end{matrix} ]$$

The armature-current calculation equation is as follows.

$${i}_{s 2}^{d} = ( {e}_{d mod} - {v}_{d} ) / {R}_{ave} ; {i}_{s 2}^{q} = ( {e}_{q mod} - {v}_{q} ) / {R}_{ave} ; {i}_{s 2}^{0} = ( {e}_{0} - {v}_{0} ) / {R}_{0}$$

$${R}_{ave} = ( {R}_{d} + {R}_{q} ) / 2 ; {e}_{d mod} = {e}_{d} - \frac{{R}_{d} - {R}_{q}}{2} {i}_{s 1}^{d} ; {e}_{q mod} = {e}_{q} - \frac{{R}_{d} - {R}_{q}}{2} {i}_{s 1}^{q}$$

The rotor-current calculation equation is as follows.

$${i}_{r} = {R}_{s r}^{d q {0}^{- 1}} ( {P}^{- 1} {h}_{s}^{P D} - {v}_{s}^{d q 0} - {R}_{s s}^{d q 0} {i}_{s}^{d q 0} ) ;$$

$${i}_{r} = {[ {i}_{f} {i}_{D} {i}_{g} {i}_{Q} ]}^{T}$$

$${v}_{s}^{d q 0} = {[ {v}_{d} {v}_{q} {v}_{0} ]}^{T}$$

$${i}_{s}^{d q 0} = {[ {i}_{s 2}^{d} {i}_{s 2}^{q} {i}_{0} ]}^{T}$$

$${h}_{s}^{P D} = - {R}_{s} {\hat{i}}_{s} + k {\hat{λ}}_{s} - {\hat{v}}_{s}$$

$$P = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ]$$

$${R}_{s s}^{d q 0} = {R}_{s} + k {L}_{s s}^{dq 0} ; {R}_{s r}^{dq 0} = k {L}_{s r}^{dq 0}$$

The stator-flux-linkage-component calculation equation is as follows.

$${λ}_{d} = {L}_{d} {i}_{s 2}^{d} + {M}_{df} {i}_{f} + {M}_{dD} {i}_{D}$$

$${λ}_{q} = {L}_{q} {i}_{s 2}^{q} + {M}_{qg} {i}_{g} + {M}_{qQ} {i}_{Q}$$

$${i}_{s 2}^{d}$$

represents the second d-component,

$${i}_{s 2}^{q}$$

represents the second q-component of a second current, R_{d}, R_{q} and R₀ are resistance parameters in a resistance matrix in the Thevenin equation, e_{d}, e_{q} and e₀ are voltage parameters in a voltage-source matrix in the Thevenin equation for the stator, θ₁ represents the first rotor angle, νₐ represents a voltage of an a-phase in the three phase-voltages, ν_{b} represents a voltage of a b-phase in the three phase-voltages, ν_{c} represents a voltage of a c-phase in the three phase-voltages, ν_{d} represents a first voltage on the d-axis among the voltage components, ν_{q} represents a second voltage on the q-axis among the voltage components, ν₀ represents a third voltage on the zero sequence among the voltage components, λ_{d} represents the d-component of the stator magnetic flux linkage, and λ_{q} represents the q-component of the stator magnetic flux linkage. The parameters of the synchronous motor comprises: a direct-axis self-inductance L_{d} of an armature winding, a direct-axis mutual inductance M_{df} between the armature winding and a field winding, a direct-axis mutual-inductance M_{dD} between the armature winding and a direct-axis damping winding D, a quadrature-axis self-inductance L_{q} of the armature winding, a quadrature-axis mutual-inductance M_{qg} between the armature winding and an quadrature-axis damping winding g, a quadrature-axis mutual-inductance M_{qQ} of the armature winding and another quadrature-axis damping winding Q, a field current i_{f}, a current i_{D} of the direct-axis damping winding D, a current i_{g} of the quadrature-axis damping winding g, and a current i_{Q} of the another quadrature-axis damping winding Q. iᵣ represents a rotor current matrix,

$${L}_{s s}^{d q 0}$$

represents a stator self-inductance matrix of the synchronous motor under the dq0 reference frame,
Rₛ represents a stator resistance matrix of the synchronous motor, k is equal to 2/Δt,

$${L}_{s r}^{d q 0}$$

represents a stator-rotor mutual-inductance matrix of the synchronous motor under the dq0 reference frame, î_{z} represents a stator current matrix obtained in a immediately previous time step, [symbol] represents a stator voltage matrix obtained in the immediately previous time step, and [symbol] represents a phase domain matrix of a stator magnetic flux linkage obtained in the immediately previous time step.

In an embodiment, the step S3 comprises: calculating the inverse of the equivalent resistance matrix in the second equation of Norton equivalent circuit to obtain the equivalent conductance matrix; inputting, before the next time step, the obtained equivalent conductance matrix into the network conductance matrix; and solving the network conductance matrix through a network solving equation to obtain the three phase-voltages. The network solving equation is YV=1, where Y represents the network conductance matrix, I represents a current matrix comprising current parameters in the second equation of Norton equivalent circuit, and V represents a voltage matrix comprising the three phase-voltages.

A system for modeling electromagnetic transients of a high-efficiency synchronous motor is further provided according to an embodiment of the present disclosure. The system comprises: a predicting module, configured to predict a first rotor angular velocity, a first rotor angle, a first quadrature-axis component (q-component) of an armature current, and a first direct-axis component (d-component) of the armature current, of a synchronous motor at a given moment through linear extrapolation; a first processing module, configured to determine, according to the first q-component and the first d-component, a first equation of Norton equivalent circuit for simulating the synchronous motor, and transform the first equation of Norton equivalent circuit expressed in a direct-quadrature-zero (dq0) reference frame into a second equation of Norton equivalent circuit expressed in a three-phase (abc) reference frame through coordinate transformation; a first calculating module, configured to determine an equivalent conductance matrix, which is an inverse of an equivalent resistance matrix in the second equation of Norton equivalent circuit, and solve a network conductance matrix, through substituting the determined equivalent conductance matrix into the network conductance matrix, to obtain three phase-voltages at ports of the synchronous motor; a second processing module, configured to determine, according to the three phase-voltages, a second q-component and a second d-component of the armature current of the synchronous motor, a rotor current of the synchronous motor, and a d-component and a q-component of a stator magnetic flux linkage of the synchronous motor; a second calculating module, configured to solve a mechanical system equation, through substituting the second q-component, the second d-component, the d-component of the stator magnetic flux linkage, and the q-component of the stator magnetic flux linkage into the mechanical system equation, to obtain a second rotor angular velocity and a second rotor angle of the synchronous motor; and a determining module, configured to obtain absolute differences between the second q-component and the first q-component, between the second d-component and the first d-component, between the second rotor angular velocity and the first rotor angular velocity, and between the second rotor angle and the first rotor angle, respectively, and output the second rotor angular velocity and the second rotor angle in response to each of the absolute differences being smaller than a respective difference threshold of said absolute difference.

In an embodiment, the mechanical system equation is:

$${T}_{gen} = \frac{p}{2} ( {λ}_{d} {i}_{s 2}^{q} - {λ}_{q} {i}_{s 2}^{d} )$$

$$ω = \frac{d θ}{dt}$$

$$J \frac{d ω}{d t} + D ω = T - {T}_{gen} ,$$

where p represents a number of poles in the synchronous motor, λ_{q} represents the q-component of the stator magnetic flux linkage, λ_{d} represents the d-component of the stator magnetic flux linkage,

$${i}_{s 2}^{d}$$

represents the second d-component,

$${i}_{s 2}^{q}$$

represents the second q-component, J represents rotational inertia of the synchronous motor, D represents a coefficient of viscosity and air-damping of the synchronous motor in air, T represents a mechanical torque of the synchronous motor, ω represents the second rotor angular velocity, θ represents the second rotor angle, and t represents time in simulation.

In an embodiment, the second processing module comprises a transforming sub-module, a first calculating sub-module, a second calculating sub-module, and a third calculating sub-module; where the transforming sub-module is configured to perform Park transformation on the three phase-voltages to obtain voltage components of a direct-axis, a quadrature-axis, and a zero sequence; where the first calculating sub-module is configured to calculate the second q-component and the second d-component according to matrix parameters of a Thevenin equation for the stator and the voltage components through an armature-current calculation equation; where the second calculating sub-module is configured to calculate the rotor current according to parameters of the synchronous motor, the voltage components, the second q-component, and the second d-component through a rotor-current calculation equation; and the third calculating sub-module is configured to calculate the d-component and the q-component of the stator magnetic flux linkage according to the parameters of the synchronous motor, the second q-component, the second d-component, and the rotor current, through a stator-flux-linkage-component calculation equation.

The Park transformation is implemented through a following equation.

$$[ \begin{matrix}{v}_{d} \\ {v}_{q} \\ {v}_{0}\end{matrix} ] = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ] [ \begin{matrix}{v}_{a} \\ {v}_{b} \\ {v}_{c}\end{matrix} ]$$

The armature-current calculation equation is as follows.

$${i}_{s 2}^{d} = ( {e}_{d mod} - {v}_{d} ) / {R}_{a v e} ; {i}_{s 2}^{q} = ( {e}_{q mod} - {v}_{q} ) / {R}_{a v e} ; {i}_{s 2}^{0} = ( {e}_{0} - {v}_{0} ) / {R}_{0}$$

$${R}_{a v e} = ( {R}_{d} + {R}_{q} ) / 2 ; {e}_{d mod} = {e}_{d} - \frac{{R}_{d} - {R}_{q}}{2} {i}_{s 1}^{d} ; {e}_{q mod} = {e}_{q} - \frac{{R}_{d} - {R}_{q}}{2} {i}_{s 1}^{q}$$

The rotor-current calculation equation is as follows.

$${i}_{r} = {R}_{s r}^{d q {0}^{- 1}} ( {P}^{- 1} {h}_{s}^{P D} - {v}_{s}^{d q 0} - {R}_{s s}^{d q 0} {i}_{s}^{d q 0} ) ;$$

$${i}_{r} = {[ {i}_{f} {i}_{D} {i}_{g} {i}_{Q} ]}^{T}$$

$${v}_{s}^{d q 0} = {[ {v}_{d} {v}_{q} {v}_{0} ]}^{T}$$

$${i}_{s}^{d q 0} = {[ {i}_{s 2}^{d} {i}_{s 2}^{q} {i}_{0} ]}^{T}$$

$${h}_{s}^{P D} = - {R}_{s} {\hat{i}}_{s} + k {\hat{λ}}_{s} - {\hat{v}}_{s}$$

$$P = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ]$$

$${R}_{s s}^{dq 0} = {R}_{s} + k {L}_{s s}^{d q 0} ; {R}_{s r}^{dq 0} = k {L}_{s r}^{dq 0}$$

The stator-flux-linkage-component calculation equation is as follows.

$${λ}_{d} = {L}_{d} {i}_{s 2}^{d} + {M}_{df} {i}_{f} + {M}_{dD} {i}_{D}$$

$${λ}_{q} = {L}_{q} {i}_{s 2}^{q} + {M}_{qg} {i}_{g} + {M}_{qQ} {i}_{Q}$$

$${i}_{s 2}^{d}$$

represents the second d-component,

$${i}_{s 2}^{q}$$

represents the second 1-component of a second current, R_{d}, R_{q} and R₀ are resistance parameters in a resistance matrix in the Thevenin equation, e_{d}, eq and e₀are voltage parameters in a voltage-source matrix in the Thevenin equation for the stator, θ₁ represents the first rotor angle, νₐ represents a voltage of an a-phase in the three phase-voltages, ν_{b} represents a voltage of a b-phase in the three phase-voltages, ν_{c} represents a voltage of a c-phase in the three phase-voltages, ν_{d} represents a first voltage on the d-axis among the voltage components, ν_{q} represents a second voltage on the q-axis among the voltage components, ν₀ represents a third voltage on the zero sequence among the voltage components, λ_{d} represents the d-component of the stator magnetic flux linkage, and λ_{q} represents the q-component of the stator magnetic flux linkage. The parameters of the synchronous motor comprises: a direct-axis self-inductance L_{d} of an armature winding, a direct-axis mutual inductance M_{df} between the armature winding and a field winding, a direct-axis mutual-inductance M_{dD} between the armature winding and a direct-axis damping winding D, a quadrature-axis self-inductance L_{q} of the armature winding, a quadrature-axis mutual-inductance M_{qg} between the armature winding and an quadrature-axis damping winding g, a quadrature-axis mutual-inductance M_{qQ} of the armature winding and another quadrature-axis damping winding Q, a field current i_{f}, a current i_{D} of the direct-axis damping winding D, a current i_{g} of the quadrature-axis damping winding g, and a current i_{Q} of the another quadrature-axis damping winding Q. iᵣ represents a rotor current matrix,

$${L}_{ss}^{dq 0}$$

represents a stator self-inductance matrix of the synchronous motor under the dq0 reference frame, Rₛ represents a stator resistance matrix of the synchronous motor, k is equal to 2/Δt,

$${L}_{sr}^{dq 0}$$

represents a stator-rotor mutual-inductance matrix of the synchronous motor under the dq0 reference frame, î_{z} represents a stator current matrix obtained in a immediately previous time step, [symbol] represents a stator voltage matrix obtained in the immediately previous time step, and [symbol] represents a phase domain matrix of a stator magnetic flux linkage obtained in the immediately previous time step.

A device is further provided according to an embodiment of the present disclosure. The device comprises a processor and a memory, where the memory is configured to store program codes and transmit the program codes to the processor, and the processor is configured to execute instructions in the program codes to perform the foregoing method according to any foregoing embodiment.

The foregoing technical solutions according to embodiments of the present disclosure have following advantages. The method and the system for modeling electromagnetic transients of the synchronous motor, and the device, are provided according to embodiments of the present disclosure. The method comprises following steps. In step S1, the first rotor angular velocity, the first rotor angle, the first quadrature-axis component (q-component) of the armature current, and the direct-axis component (d-component) of the armature current, of the synchronous motor at the given moment are predicted through linear extrapolation. In step S2, the first equation of Norton equivalent circuit for simulating the synchronous motor is determined according to the first q-component and the first d-component, and the first equation of Norton equivalent circuit expressed in the direct-quadrature-zero (dq0) reference frame is transformed, through coordinate transformation, into the second equation of Norton equivalent circuit expressed in the three-phase (abc) reference. In step S3, the equivalent conductance matrix, which is the inverse of the equivalent resistance matrix in the second equation of Norton equivalent circuit is determined, and the network conductance matrix is solved through substituting the determined equivalent conductance matrix into the network conductance matrix, to obtain the three phase-voltages at the ports of the synchronous motor. In step S4, the second q-component and the second d-component of the armature current of the synchronous motor, the rotor current of the synchronous motor, and the d-component and the q-component of the stator magnetic flux linkage of the synchronous motor, are determined according to the three phase-voltages. In step S5, the mechanical system equation is solved through substituting the second q-component, the second d-component, the d-component of the stator magnetic flux linkage, and the q-component of the stator magnetic flux linkage into the mechanical system equation, to obtain the second rotor angular velocity and the second rotor angle of the synchronous motor. In step S6, the absolute differences between the second q-component and the first q-component, between the second d-component and the first d-component, between the second rotor angular velocity and the first rotor angular velocity, and between the second rotor angle and the first rotor angle, respectively, are obtained. The process returns to step S1 for the next time step in response to each of the absolute differences being smaller than the respective difference threshold of said absolute difference. In the foregoing method, the first rotor angular velocity, the first rotor angle, the first q-component of the armature current, and the first d-component of the armature current are predicted for the synchronous motor, the first equation of Norton equivalent circuit is established for simulating the synchronous motor, and the second equation of Norton equivalent circuit and the network conductance matrix are combined and solved to obtain the three phase-voltages of the ports of the synchronous motor. Then, the second q-component, the second d-component, the second rotor angular velocity, and the second rotor angle are obtained according to the three phase-voltages. An iterative process under an error control is utilized to determine a result of the simulation of the electromagnetic transient of the synchronous motor. Historical values and current values of rotational electromotive force of the synchronous motor are not calculated, which improves accuracy of the simulation. Moreover, a result of the calculation can reach accuracy of phase-domain models while maintaining computational efficiency of dq0 models. That is, the method provided herein has high simulation accuracy and fast calculation efficiency and is applicable to development of simulation software for electromagnetic transient of power systems in practical engineering. Addressed is a technical issue that utilization of the dq0 models as rotating motor models in conventional software for electromagnetic transient simulation results in accumulated error and inaccuracy in case of a large step size in simulation.

### BRIEF DESCRIPTION OF THE DRAWINGS

Hereinafter drawings to be applied in embodiments of the present disclosure or in conventional technology are briefly described, in order to clarify illustration of technical solutions according to embodiments of the present disclosure or in conventional technology. Apparently, the drawings in the following descriptions are only some embodiments of the present disclosure, and other drawings may be obtained by those skilled in the art based on the provided drawings without exerting creative efforts.

FIG. 1 is a flow chart of a method for modeling electromagnetic transients of a high-efficiency synchronous motor according to an embodiment of the present disclosure.

FIG. 2 is a schematic block diagram of a system for modeling electromagnetic transients of a high-efficiency synchronous motor according to an embodiment of the present disclosure.

### DETAILED DESCRIPTION OF THE EMBODIMENTS

Hereinafter technical solutions in embodiments of the present disclosure are described clearly and completely in conjunction with the drawings in embodiments of the present closure to improve clarity and intelligibility of objectives, features, and advantages of embodiments of the present disclosure. Apparently, the described embodiments are only some rather than all of the embodiments of the present disclosure. Any other embodiments obtained based on the embodiments of the present disclosure by those skilled in the art without any creative effort fall within the scope of protection of the present disclosure.

A method and a system for modelling electromagnetic transients of a high-efficiency synchronous motor, and a device, are provided according to embodiments of the present disclosure. Addressed is a technical issue that utilization of dq0 models as rotating motor models in conventional software for electromagnetic transient simulation results in accumulated error and inaccuracy in case of a large step size in simulation.

### First Embodiment

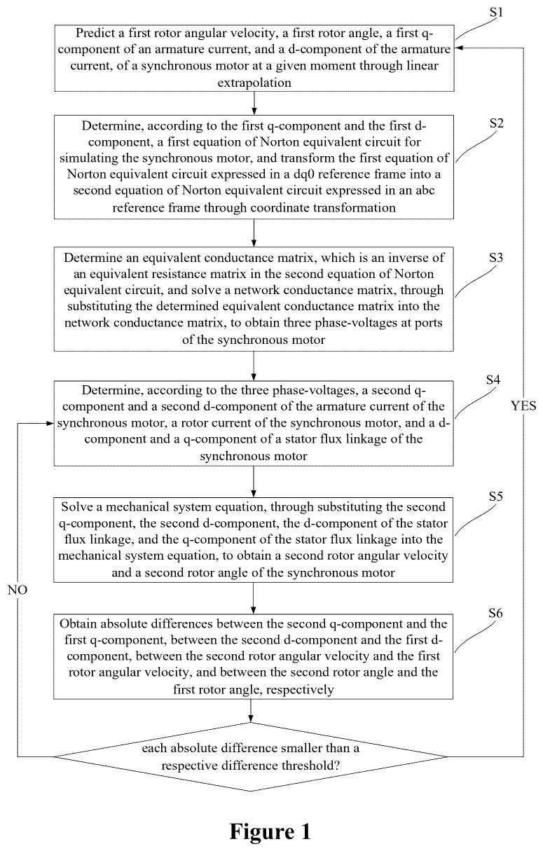

FIG. 1 is a flow chart of a method for modeling electromagnetic transients of a high-efficiency synchronous motor according to an embodiment of the present disclosure. Here a generator is taken as an example of the synchronous motor.

Reference is made to FIG. 1. In an embodiment, a method for modeling electromagnetic transients of a high-efficiency synchronous motor comprises following steps step S1 to step S6.

In step S1, a first rotor angular velocity, a first rotor angle, a first quadrature-axis component (q-component) of an armature current, and a first direct-axis component (d-component) of the armature current, of a synchronous motor at a given moment are predicted through linear extrapolation.

In an embodiment, the first rotor angular velocity of the synchronous motor is predicted through linear extrapolation as follow: ω₁(t)=2ω₁(t−Δt)−ω₁(t−2Δt). t represents time in simulation of the synchronous motor, specifically the given moment. Δt represents a step size in the simulation. Then, the first rotor angle may be obtained through performing trapezoidal integration on the first rotor angular velocity.

An equation of the trapezoidal integration may be as follows:

$${θ}_{1} ( t ) = {θ}_{1} ( t - Δ t ) - \frac{Δ t}{2} \{ {ω}_{1} ( t - Δ t ) + {ω}_{1} ( t ) \} .$$

Here the linear extrapolation method may be further adopted for predicting the first q-component and the first d-component of the armature current at the given moment.

An equation for predicting the first d-component of the armature current at the given moment through the linear extrapolation may be as follows:

$${i}_{s 1}^{d} ( t ) = 2 {i}_{s 1}^{d} ( t - Δ t ) - {i}_{s 1}^{d} ( t - 2 Δ t ) .$$

An equation for predicting the first q-component of the armature current at the given moment through the linear extrapolation may be as follows:

$${i}_{s 1}^{q} ( t ) = 2 {i}_{s 1}^{q} ( t - Δ t ) - {i}_{s 1}^{q} ( t - 2 Δ t ) .$$

In step S2, a first equation of Norton equivalent circuit for simulating the synchronous motor is determined according to the first q-component and the first d-component, and the first equation of Norton equivalent circuit expressed in a direct-quadrature-zero (dq0) reference frame is transformed into a second equation of Norton equivalent circuit expressed in a three-phase (abc) reference frame through coordinate transformation. That is, the first q-component and the first d-component are processed to obtain a first current on a direct-axis, a second current on a quadrature-axis, and a third current of a zero sequence, which present in the first equation of Norton equivalent circuit. The first current, the second current, and the third current are subject coordinate transformation to obtain a first current, a second current, and a third current of phases a, b, and c, respectively, which present in the second equation of Norton equivalent circuit.

This step mainly processes the first rotor angular velocity and the first rotor angle, which are predicted in step S1, to construct the first equation of Norton equivalent circuit, which is an equivalence of the synchronous motor. Thereby, the first current on the direct-axis, the second current on the quadrature-axis, and the third current of the zero sequence, in the first equation of Norton equivalent circuit are obtained for the synchronous motor simplified as a resistor and a current source that are connected parallel. Then, the first current on the direct-axis, the second current on the quadrature-axis, and the third current of the zero sequence are transformed from the dq0 reference frame into the first current, the second current, and the third current of the second equation of Norton equivalent circuit under the abc reference frame.

In step S3, an equivalent conductance matrix, which is an inverse of an equivalent resistance matrix in the second equation of Norton equivalent circuit is determined, and a network conductance matrix is solved, through substituting the determined equivalent conductance matrix into the network conductance matrix, to obtain three phase-voltages at ports of the synchronous motor. That is, the first current, the second current, and the third current of phases a, b, and c are substituted into the network conductance matrix to obtain the three phase-voltages to the first current, the second current and the third current, respectively. The three phase-voltages are called an a-phase voltage, a b-phase voltage, and a c-phase voltage.

Solving the network conductance matrix through substituting the determined equivalent conductance matrix into the network conductance matrix comprises following steps. Before the next time step, the inverse of the equivalent resistance matrix in the second equation of Norton equivalent circuit is calculated to obtain the equivalent conductance matrix. Then, the obtained equivalent conductance matrix is inputted into the network conductance matrix, and the network conductance matrix is solved through a network solving equation to obtain the three phase-voltages. The network solving equation is YV=1. Y represents the network conductance matrix. I represents history current source(s) of the whole network and comprises a current matrix comprising current parameters in the second equation of Norton equivalent circuit. V represents three-phase voltages of to-be-solved nodes in the entire network and comprises a voltage matrix comprising the three phase-voltages.

In step S4, a second q-component and a second d-component of the armature current of the synchronous motor, a rotor current of the synchronous motor, and a d-component and a q-component of a stator magnetic flux linkage of the synchronous motor, are determined according to the three phase-voltages.

The second q-component, the second d-component, the rotor current, the d-component of the stator magnetic flux linkage, and the q-component of the stator magnetic flux linkage are calculated through performing Park transformation on the a-phase voltage, the b-phase voltage, and the c-phase voltage.

In step S5, a mechanical system equation is solved through substituting the second q-component, the second d-component, the d-component of the stator magnetic flux linkage, and the q-component of the stator magnetic flux linkage into the mechanical system equation, to obtain a second rotor angular velocity and a second rotor angle of the synchronous motor.

This step mainly inputs the second q-component, the second d-component, the d-component of the stator magnetic flux linkage, and the q-component of the stator magnetic flux linkage, which are obtained in step S4, into the mechanical system equation to obtain the second rotor angular velocity and the second rotor angle.

In an embodiment, the mechanical system equation is as follows.

$${T}_{gen} = \frac{p}{2} ( {λ}_{d} {i}_{s 2}^{q} - {λ}_{q} {i}_{s 2}^{d} ) \\ ω = \frac{d θ}{d t} \\ J \frac{d ω}{dt} + D ω = T - {T}_{gen}$$

p represents a number of poles in the synchronous motor. λ_{q} represents the q-component of the stator magnetic flux linkage, and λ_{d} represents the d-component of the stator magnetic flux linkage.

$${i}_{s 2}^{d}$$

represents the second d-component, and

$${i}_{s 2}^{q}$$

represents the second q-component. J represents rotational inertia of the synchronous motor. D represents a coefficient of viscosity and air-damping of the synchronous motor in air. T represents a mechanical torque of the synchronous motor. ω represents the second rotor angular velocity. θ represents the second rotor angle. t represents the time in simulation. T may be equal to a ratio of mechanical power P₀ of the synchronous motor to an initial angular velocity ωₛ of the synchronous motor, that is, T=P₀/ωₛ. T is a known parameter of the synchronous motor.

In step S6, absolute differences between the second q-component and the first q-component, between the second d-component and the first d-component, between the second rotor angular velocity and the first rotor angular velocity, and between the second rotor angle and the first rotor angle, respectively, are obtained. The process returns to step S1 for a next time step, in a case that each of the absolute differences is smaller than a respective difference threshold of such absolute difference.

This step mainly calculates differences between the second q-component, the second d-component, the second rotor angular velocity, and the second rotor angle, which are obtained in steps S4 and S5, and the first q-component, the first d-component, the first rotor angular velocity, and the first rotor angle, which are predicted in step S1, respectively. Absolute values of the differences are obtained, and then it is determined whether all the absolute values are less than respective error thresholds. In a case that all the absolute values of the differences s are less than their respective error thresholds, the process returns to the step S1 and performs modeling on next electromagnetic transient of the synchronous motor. In a case that any of the absolute values is not less than its respective error threshold, the process returns to the step S4 and re-calculates the second q-component, the second d-component, the second rotor angular velocity, and the second rotor angle.

The method for modeling electromagnetic transients of the synchronous motor is provided according to embodiments of the present disclosure. The method comprises following steps. In step S1, the first rotor angular velocity, the first rotor angle, the first quadrature-axis component (q-component) of the armature current, and the direct-axis component (d-component) of the armature current, of the synchronous motor at the given moment are predicted through linear extrapolation. In step S2, the first equation of Norton equivalent circuit for simulating the synchronous motor is determined according to the first q-component and the first d-component, and the first equation of Norton equivalent circuit expressed in the direct-quadrature-zero (dq0) reference frame is transformed, through coordinate transformation, into the second equation of Norton equivalent circuit expressed in the three-phase (abc) reference. In step S3, the equivalent conductance matrix, which is the inverse of the equivalent resistance matrix in the second equation of Norton equivalent circuit is determined, and the network conductance matrix is solved through substituting the determined equivalent conductance matrix into the network conductance matrix, to obtain the three phase-voltages at the ports of the synchronous motor. In step S4, the second q-component and the second d-component of the armature current of the synchronous motor, the rotor current of the synchronous motor, and the d-component and the q-component of the stator magnetic flux linkage of the synchronous motor, are determined according to the three phase-voltages. In step S5, the mechanical system equation is solved through substituting the second q-component, the second d-component, the d-component of the stator magnetic flux linkage, and the q-component of the stator magnetic flux linkage into the mechanical system equation, to obtain the second rotor angular velocity and the second rotor angle of the synchronous motor. In step S6, the absolute differences between the second q-component and the first q-component, between the second d-component and the first d-component, between the second rotor angular velocity and the first rotor angular velocity, and between the second rotor angle and the first rotor angle, respectively, are obtained. The process returns to step S1 for the next time step in response to each of the absolute differences being smaller than the respective difference threshold of said absolute difference. In the foregoing method, the first rotor angular velocity, the first rotor angle, the first q-component of the armature current, and the first d-component of the armature current are predicted for the synchronous motor, the first equation of Norton equivalent circuit is established for simulating the synchronous motor, and the second equation of Norton equivalent circuit and the network conductance matrix are combined and solved to obtain the three phase-voltages of the ports of the synchronous motor. Then, the second q-component, the second d-component, the second rotor angular velocity, and the second rotor angle are obtained according to the three phase-voltages. An iterative process under an error control is utilized to determine a result of the simulation of the electromagnetic transient of the synchronous motor. Historical values and current values of rotational electromotive force of the synchronous motor are not calculated, which improves accuracy of the simulation. Moreover, a result of the calculation can reach accuracy of phase-domain models while maintaining computational efficiency of dq0 models. That is, the method provided herein has high simulation accuracy and fast calculation efficiency and is applicable to development of simulation software for electromagnetic transient of power systems in practical engineering. Addressed is a technical issue that utilization of the dq0 models as rotating motor models in conventional software for electromagnetic transient simulation results in accumulated error and inaccuracy in case of a large step size in simulation.

In an embodiment, step S2 comprises following sub-steps.

A stator-rotor voltage equation of the synchronous motor is obtained, and the stator-rotor voltage equation is discretized through an implicit trapezoidal rule to obtain a first transformation equation.

Park transformation is performed on the first transformation equation, a rotor variable in the first transformation equation is eliminated, and average resistance for a direct-axis and a quadrature-axis is utilized, to obtain a Thevenin equation for a stator.

The Thevenin equation for the stator is mathematically transformed to the first equation of Norton equivalent circuit.

The first equation of Norton equivalent circuit expressed in the dq0 reference frame is transformed into the second equation of Norton equivalent circuit expressed in the abc reference frame through phasor coordinate transformation. A first current on a direct-axis, a second current value on a quadrature-axis, and a third current of a zero sequence are derivable according to the first equation of Norton equivalent circuit. A first current of an a-phase current source, a second current of a b-phase current source, and a third current of a c-phase current source are derivable according to the second equation of Norton equivalent circuit. The Thevenin equation for the stator is expressed as a symmetric matrix in which a resistance matrix has constant elements.

In an embodiment, the first equation of Norton equivalent circuit is as follows.

$${i}_{d \cdot source} = \frac{{e}_{d mod}}{{R}_{ave}} ; {i}_{q \cdot source} = \frac{{e}_{q mod}}{{R}_{ave}} ; {i}_{0 \cdot source} = \frac{{e}_{0}}{{R}_{0}} \\ {R}_{ave} = ( {R}_{d} + {R}_{q} ) / 2 ; \\ {e}_{d mod} = {e}_{d} - \frac{{R}_{d} - {R}_{q}}{2} {i}_{s 1}^{d} ; {e}_{q mod} = {e}_{q} - \frac{{R}_{d} - {R}_{q}}{2} {i}_{s 1}^{q}$$

The phasor coordinate transformation formula is as follows.

$$[ \begin{matrix}{i}_{a \cdot source} \\ {i}_{b \cdot source} \\ {i}_{c \cdot source}\end{matrix} ] = \frac{\sqrt{2}}{\sqrt{3}} [ \begin{matrix}cos {θ}_{1} & sin {θ}_{1} & \frac{1}{\sqrt{2}} \\ cos ( {θ}_{1} - 120 ° ) & sin ( {θ}_{1} - 120 ° ) & \frac{1}{\sqrt{2}} \\ cos ( {θ}_{1} + 120 ° ) & sin ( {θ}_{1} + 120 ° ) & \frac{1}{\sqrt{2}}\end{matrix} ] [ \begin{matrix}{i}_{d \cdot source} \\ {i}_{q \cdot source} \\ {i}_{0 \cdot source}\end{matrix} ]$$

$${i}_{s 1}^{d}$$

represents the first d-component, and

$${i}_{s 1}^{q}$$

represents the first q-component. R_{d}, R_{q} and R₀ are resistance parameters in a resistance matrix in the Thevenin equation. e_{d}, e_{q} and e₀ are voltage parameters in a voltage-source matrix in the Thevenin equation. In the first equation of Norton equivalent circuit, i_{d, source} represents the first current of the direct-axis in a first Norton equivalent circuit, i_{q, source} represents the second current of the quadrature-axis in the first Norton equivalent circuit, and i_{0, source} represents the third current of the zero component in the first Norton equivalent circuit. θ₁ represents a first rotor angle. In the second equation of Norton equivalent circuit, i_{a, source} represents the first current of the a-phase current source in a second Norton equivalent circuit, i_{b, source} represents the second current of the b-phase current source in the second Norton equivalent circuit, and i_{c, source} represents the third current of the c-phase current source in the second Norton equivalent circuit.

In an embodiment, the stator-rotor voltage equation and a magnetic flux linkage equation of the synchronous motor are obtained, and the stator-rotor voltage equation is discretized through the implicit trapezoidal rule to obtain the first transformation equation. Then, Park transformation is performed on the first transformation equation, the rotor variable(s) in the first transformation equation is eliminated, and the average resistance for the direct-axis and the quadrature-axis is utilized to obtain the Thevenin equation for the stator.

The stator-rotor voltage equation is as follows.

$$[ \begin{matrix}{v}_{s}^{abc} \\ {v}_{r}\end{matrix} ] = - [ \begin{matrix}{R}_{s} & 0 \\ 0 & {R}_{r}\end{matrix} ] [ \begin{matrix}{i}_{s}^{abc} \\ {i}_{r}\end{matrix} ] - \frac{d}{dt} [ \begin{matrix}{λ}_{s}^{abc} \\ {λ}_{r}\end{matrix} ]$$

The magnetic flux linkage equation is as follows.

$$[ \begin{matrix}{λ}_{s}^{abc} \\ {λ}_{r}\end{matrix} ] = L ( {θ}_{1} ) [ \begin{matrix}{i}_{s}^{abc} \\ {i}_{r}\end{matrix} ] = [ \begin{matrix}{L}_{ss} & {L}_{sr} \\ {L}_{rs} & {L}_{rr}\end{matrix} ] [ \begin{matrix}{i}_{s}^{abc} \\ {i}_{r}\end{matrix} ]$$

The first transformation equation is follows.

$$[ \begin{matrix}{v}_{s}^{abc} \\ {v}_{r}\end{matrix} ] = - [ \begin{matrix}{R}_{s} + {kL}_{ss} & {kL}_{sr} \\ {kL}_{rs} & {R}_{r} + {kL}_{rr}\end{matrix} ] [ \begin{matrix}{i}_{s}^{abc} \\ {i}_{r}\end{matrix} ] + [ \begin{matrix}{h}_{s}^{PD} \\ {h}_{r}^{PD}\end{matrix} ]$$

$${h}_{s}^{PD} = - {R}_{s} {\hat{i}}_{s} + k {\hat{λ}}_{s} - {\hat{v}}_{s}$$

$${h}_{r}^{PD} = - {R}_{r} {\hat{i}}_{r} + k {\hat{λ}}_{r} - {\hat{v}}_{r}$$

$$P = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ]$$

The Thevenin equation for the stator is as follows.

$${v}_{s}^{dq 0} = - {R}_{dq 0} {i}_{s}^{dq 0} + {e}_{dq 0}$$

$${R}_{dq 0} = diag ( {R}_{d} , {R}_{q} , {R}_{0} ) = {R}_{ss}^{dq 0} - {R}_{sr}^{dq 0} {R}_{rr}^{- 1} {R}_{rs}^{dq 0}$$

$${e}_{dq 0} = {\begin{matrix}[ {e}_{d} & {e}_{q} & {e}_{0} ]\end{matrix}}^{T} = {R}_{sr}^{dq 0} {R}_{rr}^{- 1} ( {v}_{r} - {h}_{r}^{PD} ) + {P}^{- 1} {h}_{s}^{PD}$$

$${v}_{s}^{a b c}$$

represents a stator phase, domain voltage matrix in a phase-domain matrix of the synchronous motor,

$${i}_{s}^{a b c}$$

represents a stator current phase-domain matrix in the phase-domain matrix of the synchronous motor, and

$${λ}_{s}^{a b c}$$

represents a magnetic-flux-linkage phase-domain matrix in the phase-domain matrix of the synchronous motor. νᵣ represents a rotor voltage matrix a magnetic-flux-linkage matrix of the synchronous motor, iᵣ represents a rotor current matrix in the magnetic-flux-linkage matrix of the synchronous motor, and λᵣ represents a magnetic-flux-linkage matrix in the magnetic-flux-linkage matrix of the synchronous motor. Rₛ represents a stator resistance matrix of the synchronous motor, and Rᵣ represents a rotor resistance of the synchronous motor. L(θ₁) represents an inductance of the synchronous motor with respect to the first rotor angle. Lₛₛ represents a stator self-inductance in a self-inductance matrix of the synchronous motor, Lᵣᵣ represents a rotor self-inductance in the self-inductance matrix of the synchronous motor, Lₛᵣ represents a stator mutual-inductance in an inductance matrix of the synchronous motor, and Lᵣₛ represents a rotor mutual-inductance in the inductance matrix of the synchronous motor. k is equal to 2/Δt. A variable marked with \hat{ } represents a corresponding quantity in the immediately previous time step, that is, a corresponding history quantity. R_{dq0} represents a resistance matrix for resistors in the Thevenin equation for the stator, and e_{dq0} represents a voltage-source matrix for voltage sources in series connection with the resistors. [symbol] in

$${h}_{s}^{PD}$$

are obtained directly from history solution quantities of the network. î_{z} and [symbol] are obtained through performing Park transformation on corresponding history current variables and history magnetic-flux-linkage variables under the dq0 reference frame. A value at the last moment is also utilized for νᵣ.

In an embodiment, the Park transformation is performed on the first transformation equation to obtain the second transformation equation, and then the rotor variable(s) in the second transformation equation are eliminated to obtain the Thevenin equation.

The second transformation equation is follows.

$$[ \begin{matrix}{v}_{s}^{dq 0} \\ {v}_{r}\end{matrix} ] = - [ \begin{matrix}{R}_{ss}^{dq 0} & {R}_{sr}^{dq 0} \\ {R}_{rs}^{dq 0} & {R}_{rr}^{dq 0}\end{matrix} ] [ \begin{matrix}{i}_{s}^{dq 0} \\ {i}_{r}\end{matrix} ] + [ \begin{matrix}{P}^{- 1} {h}_{s}^{PD} \\ {h}_{r}^{PD}\end{matrix} ]$$

$$[ \begin{matrix}{R}_{ss}^{dq 0} & {R}_{sr}^{dq 0} \\ {R}_{rs}^{dq 0} & {R}_{rr}^{dq 0}\end{matrix} ] = [ \begin{matrix}{R}_{s} + {kL}_{ss}^{dq 0} & {kL}_{sr}^{dq 0} \\ {kL}_{rs}^{dq 0} & {R}_{r} + {kL}_{rr}^{dq 0}\end{matrix} ]$$

$${v}_{s}^{d q 0}$$

represents a stator voltage matrix of the synchronous motor under the dq0 reference frame, and

$${i}_{s}^{dq 0}$$

represents of a stator current matrix of the synchronous motor under the dq0 reference frame,

$${L}_{ss}^{dq 0}$$

represents a stator self-inductance matrix of the synchronous motor under the dq0 reference frame,

$${L}_{s r}^{dq 0}$$

represents a stator-rotor mutual-inductance matrix of the synchronous motor under the dq0 reference frame, and

$${L}_{r s}^{dq 0}$$

represents a rotor-stator mutual-inductance matrix of the synchronous motor under the dq0 reference frame.

The obtained Thevenin equation is under the dq0 reference frame. In an embodiment, the average resistance is utilized for the direct-axis and the quadrature-axis to obtain the modified Thevenin equation which is transformed to the stator side. Thereby, it is avoided to generate a time-varying and dissymmetrical resistance matrix that is three by three in size, and calculation accuracy is improved. The second equation of Norton equivalent circuit after the transformation is as follows.

$$[ \begin{matrix}{v}_{s}^{d} \\ {v}_{s}^{q} \\ {v}_{s}^{0}\end{matrix} ] = [ \begin{matrix}{e}_{d , m o d} \\ {e}_{q , m o d} \\ {e}_{0 , m o d}\end{matrix} ] - [ \begin{matrix}{R}_{ave} & & \\ & {R}_{ave} & \\ & & {R}_{0}\end{matrix} ] [ \begin{matrix}{i}_{s 1}^{d} \\ {i}_{s 1}^{q} \\ {i}_{s 1}^{0}\end{matrix} ] .$$

In an embodiment, step S4 comprises following sub-steps.

Park transformation is performed on the three phase-voltages to obtain voltage components of a direct-axis, a quadrature-axis, and a zero sequence.

The second q-component and the second d-component are calculated according to matrix parameters of the Thevenin equation for the stator and the voltage components through an armature-current calculation equation.

The rotor current is calculated according to parameters of the synchronous motor, the voltage components, the second q-component, and the second d-component through a rotor-current calculation equation.

The d-component and the q-component of the stator magnetic flux linkage are calculated according to the parameters of the synchronous motor, the second q-component, the second d-component, and the rotor current, through a stator-flux-linkage-component calculation equation. The three phase-voltages comprise a voltage of the a-phase, a voltage of the b-phase, and a voltage of the c-phase. The voltage components of the direct-axis, the quadrature-axis, and the zero sequence comprises a first voltage of the direct-axis, a second voltage of the quadrature-axis, and a third voltage of the zero sequence.

In an embodiment, the Park transformation is implemented through a following equation.

$$[ \begin{matrix}{v}_{d} \\ {v}_{q} \\ {v}_{0}\end{matrix} ] = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ] [ \begin{matrix}{v}_{a} \\ {v}_{b} \\ {v}_{c}\end{matrix} ]$$

The armature-current calculation equation is as follows.

$$\begin{matrix}\begin{matrix}{i}_{s 2}^{d} = ( {e}_{d mod} - {v}_{d} ) / {R}_{a v e} ; & {i}_{s 2}^{q} = ( {e}_{q mod} - {v}_{q} ) / {R}_{a v e} ; & {i}_{s 2}^{0} = ( {e}_{0} - {v}_{0} ) / {R}_{0}\end{matrix} \\ \begin{matrix}{R}_{a v e} = ( {R}_{d} + {R}_{q} ) / 2 ; & {e}_{d mod} = {e}_{d} - \frac{{R}_{d} - {R}_{q}}{2} {i}_{s 1}^{d} ; & {e}_{q mod} = {e}_{q} - \frac{{R}_{d} - {R}_{q}}{2} {i}_{s 1}^{q}\end{matrix}\end{matrix}$$

The rotor-current calculation equation is as follows.

$$\begin{matrix}{i}_{r} = {R}_{s r}^{d q {0}^{- 1}} ( {P}^{- 1} {h}_{s}^{P D} - {v}_{s}^{d q 0} - {R}_{s s}^{d q 0} {i}_{s}^{d q 0} ) ; \\ {i}_{r} = {[ \begin{matrix}{i}_{f} & {i}_{D} & {i}_{g} & {i}_{Q}\end{matrix} ]}^{T} \\ {v}_{s}^{d q 0} = {[ \begin{matrix}{v}_{d} & {v}_{q} & {v}_{0}\end{matrix} ]}^{T} \\ {i}_{s}^{d q 0} = {[ \begin{matrix}{i}_{s 2}^{d} & {i}_{s 2}^{q} & {i}_{0}\end{matrix} ]}^{T}\end{matrix}$$

$${h}_{s}^{P D} = - {R}_{s} {\hat{i}}_{s} + k {\hat{λ}}_{s} - {\hat{v}}_{s}$$

$$P = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ]$$

$${R}_{s s}^{d q 0} = {R}_{s} + k {L}_{s s}^{d q 0} ; {R}_{s r}^{dq 0} = k {L}_{s r}^{d q 0}$$

The stator-flux-linkage-component calculation equation is as follows.

$$\begin{matrix}{λ}_{d} = {L}_{d} {i}_{s 2}^{d} + {M}_{d f} {i}_{f} + {M}_{d D} {i}_{D} \\ {λ}_{q} = {L}_{q} {i}_{s 2}^{q} + {M}_{q g} {i}_{g} + {M}_{q Q} {i}_{Q}\end{matrix}$$

$${i}_{s 2}^{d}$$

represents the second d-component, and

$${i}_{s 2}^{q}$$

represents the second q-component of a second current. R_{d}, R_{q} and R₀ are resistance parameters in a resistance matrix in the Thevenin equation. e_{d}, eq and e₀ are voltage parameters in a voltage-source matrix in the Thevenin equation for the stator. θ₁ represents the first rotor angle. νₐ represents the voltage of the a-phase in the three phase-voltages, ν_{b} represents the voltage of the b-phase in the three phase-voltages, and ν_{c} represents the voltage of the c-phase in the three phase-voltages. ν_{d} represents the first voltage of the d-axis among the voltage components, ν_{q} represents the second voltage the the q-axis among the voltage components, and ν₀ represents the third voltage on the zero sequence among the voltage components. λ_{d} represents the d-component of the stator magnetic flux linkage, and λ_{q} represents the q-component of the stator magnetic flux linkage. The parameters of the synchronous motor comprises: a direct-axis self-inductance L_{d} of an armature winding, a direct-axis mutual inductance M_{df} between the armature winding and a field winding, a direct-axis mutual-inductance M_{dD} between the armature winding and a direct-axis damping winding D, a quadrature-axis self-inductance L_{q} of the armature winding, a quadrature-axis mutual-inductance M_{qg} between the armature winding and an quadrature-axis damping winding g, a quadrature-axis mutual-inductance M_{qQ} of the armature winding and another quadrature-axis damping winding Q, a field current i_{f}, a current i_{D} of the direct-axis damping winding D, a current i_{g} of the quadrature-axis damping winding g, and a current i_{Q} of the another quadrature-axis damping winding Q. iᵣ represents a rotor current matrix.

$${L}_{s s}^{d q 0}$$

represents a stator seir-inductance matrix of the synchronous motor under the dq0 reference frame. Rₛ represents a stator resistance matrix of the synchronous motor. k is equal to 2/Δt.

$${L}_{s r}^{d q 0}$$

represents a stator-rotor mutual-inductance matrix of the synchronous motor under the dq0 reference frame. î_{z} represents a stator current matrix obtained in a immediately previous time step, [symbol] represents a stator voltage matrix obtained in the immediately previous time step, and [symbol] represents a phase domain matrix of a stator magnetic flux linkage obtained in the immediately previous time step.

In an embodiment, in step S3, the equivalent resistance matrix R_{equiv} is constructed according to the Thevenin equation, and the inverse of the equivalent resistance matrix is calculated to obtain the equivalent conductance matrix. Before entering a next cycle for the next step, the first current, the second current, and the third current of the three phases, and the equivalent conductance matrix, are all inputted into a network equation, and the network equation is solved to obtain the a-phase voltage, the b-phase voltage, and the c-phase voltage.

The equivalent resistance matrix is as follows.

$$\begin{matrix}[ {R}_{equiv} ] = [ \begin{matrix}{R}_{s} & {R}_{m} & {R}_{m} \\ {R}_{m} & {R}_{s} & {R}_{m} \\ {R}_{m} & {R}_{m} & {R}_{s}\end{matrix} ] \\ {R}_{m} = ( {R}_{0} - {R}_{a v e} ) / 3 \\ {R}_{s} = ( {R}_{0} + 2 {R}_{a v e} ) / 3\end{matrix} .$$

### Second Embodiment

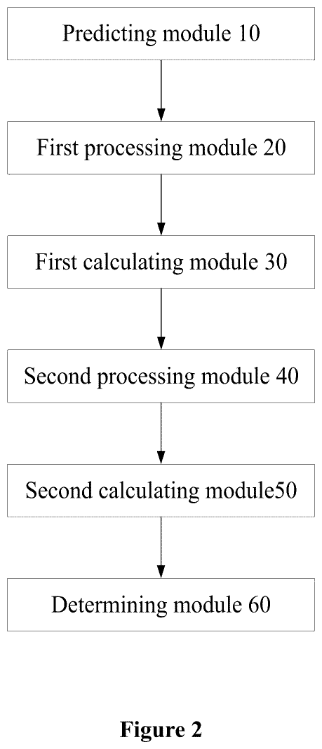

FIG. 2 is a block diagram of a system for modeling electromagnetic transients of a high-efficiency synchronous motor according to an embodiment of the present disclosure.

Reference is made to FIG. 2. In an embodiment, a system for modeling electromagnetic transients of a high-efficiency synchronous motor comprises a predicting module 10, a first processing module 20, a first calculating module 30, a second processing module 40, a second calculating module 50, and a determining module 60.

The predicting module 10 is configured to predict a first rotor angular velocity, a first rotor angle, a first quadrature-axis component (q-component) of an armature current, and a first direct-axis component (d-component) of the armature current, of a synchronous motor at a given moment through linear extrapolation.

The first processing module 20 is configured to determine, according to the first q-component and the first d-component, a first equation of Norton equivalent circuit for simulating the synchronous motor, and transform the first equation of Norton equivalent circuit expressed in a direct-quadrature-zero (dq0) reference frame into a second equation of Norton equivalent circuit expressed in a three-phase (abc) reference frame through coordinate transformation.

The first calculating module 30 is configured to determine an equivalent conductance matrix, which is an inverse of an equivalent resistance matrix in the second equation of Norton equivalent circuit, and solve a network conductance matrix, through substituting the determined equivalent conductance matrix into the network conductance matrix, to obtain three phase-voltages at ports of the synchronous motor.

The second processing module 40 is configured to determine, according to the three phase-voltages, a second q-component and a second d-component of the armature current of the synchronous motor, a rotor current of the synchronous motor, and a d-component and a q-component of a stator magnetic flux linkage of the synchronous motor.

The second calculating module 50 is configured to solve a mechanical system equation, through substituting the second q-component, the second d-component, the d-component of the stator magnetic flux linkage, and the q-component of the stator magnetic flux linkage into the mechanical system equation, to obtain a second rotor angular velocity and a second rotor angle of the synchronous motor.

The determining module 60 is configured to obtain absolute differences between the second q-component and the first q-component, between the second d-component and the first d-component, between the second rotor angular velocity and the first rotor angular velocity, and between the second rotor angle and the first rotor angle, respectively, and output the second rotor angular velocity and the second rotor angle in response to each of the absolute differences being smaller than a respective difference threshold of said absolute difference.

In an embodiment, the mechanical system equation is as follows.

$$\begin{matrix}{T}_{g e n} = \frac{p}{2} ( {λ}_{d} {i}_{s 2}^{q} - {λ}_{q} {i}_{s 2}^{d} ) \\ ω = \frac{d θ}{dt} \\ J \frac{d ω}{d t} + D ω = T - {T}_{g e n}\end{matrix}$$

p represents a number of poles in the synchronous motor, λ_{q} represents the q-component of the stator magnetic flux linkage, λ_{d} represents the d-component of the stator magnetic flux linkage,

$${i}_{s 2}^{d}$$

represents the second d-component,

$${i}_{s 2}^{q}$$

represents the second q-component, J represents the second q-component, J represents rotational inertia of the synchronous motor, D represents a coefficient of viscosity and air-damping of the synchronous motor in air, T represents a mechanical torque of the synchronous motor, ω represents the second rotor angular velocity, θ represents the second rotor angle, and t represents time in simulation.

In an embodiment, the second processing module comprises a transforming sub-module, a first calculating sub-module, a second calculating sub-module, and a third calculating sub-module.

The transforming sub-module is configured to perform Park transformation on the three phase-voltages to obtain voltage components of a direct-axis, a quadrature-axis, and a zero sequence.

The first calculating sub-module is configured to calculate the second q-component and the second d-component according to matrix parameters of a Thevenin equation for the stator and the voltage components through an armature-current calculation equation.

The second calculating sub-module is configured to calculate the rotor current according to parameters of the synchronous motor, the voltage components, the second q-component, and the second d-component through a rotor-current calculation equation.

The third calculating sub-module is configured to calculate the d-component and the q-component of the stator magnetic flux linkage according to the parameters of the synchronous motor, the second q-component, the second d-component, and the rotor current, through a stator-flux-linkage-component calculation equation.

The Park transformation is implemented through a following equation.

$$[ \begin{matrix}{v}_{d} \\ {v}_{q} \\ {v}_{0}\end{matrix} ] = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ] [ \begin{matrix}{v}_{a} \\ {v}_{b} \\ {v}_{c}\end{matrix} ]$$

The armature-current calculation equation is as follows.

$$\begin{matrix}\begin{matrix}{i}_{s 2}^{d} = ( {e}_{d mod} - {v}_{d} ) / {R}_{a v e} ; & {i}_{s 2}^{q} = ( {e}_{q mod} - {v}_{q} ) / {R}_{a v e} ; & {i}_{s 2}^{0} = ( {e}_{0} - {v}_{0} ) / {R}_{0}\end{matrix} \\ \begin{matrix}{R}_{a v e} = ( {R}_{d} + {R}_{q} ) / 2 ; & {e}_{d mod} = {e}_{d} - \frac{{R}_{d} - {R}_{q}}{2} {i}_{s 1}^{d} ; & {e}_{q mod} = {e}_{q} - \frac{{R}_{d} - {R}_{q}}{2} {i}_{s 1}^{q}\end{matrix}\end{matrix}$$

The rotor-current calculation equation is as follows.

$$\begin{matrix}{i}_{r} = {R}_{s r}^{d q {0}^{- 1}} ( {P}^{- 1} {h}_{s}^{P D} - {v}_{s}^{d q 0} - {R}_{s s}^{d q 0} {i}_{s}^{d q 0} ) ; \\ {i}_{r} = {[ \begin{matrix}{i}_{f} & {i}_{D} & {i}_{g} & {i}_{Q}\end{matrix} ]}^{T} \\ {v}_{s}^{d q 0} = {[ \begin{matrix}{v}_{d} & {v}_{q} & {v}_{0}\end{matrix} ]}^{T} \\ {i}_{s}^{d q 0} = {[ \begin{matrix}{i}_{s 2}^{d} & {i}_{s 2}^{q} & {i}_{0}\end{matrix} ]}^{T}\end{matrix}$$

$${h}_{s}^{P D} = - {R}_{s} {\hat{i}}_{s} + k {\hat{λ}}_{s} - {\hat{v}}_{s}$$

$$P = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ]$$

$${R}_{s s}^{d q 0} = {R}_{s} + k {L}_{s s}^{d q 0} ; {R}_{s r}^{dq 0} = k {L}_{s r}^{d q 0}$$

The stator-flux-linkage-component calculation equation is as follows.

$$\begin{matrix}{λ}_{d} = {L}_{d} {i}_{s 2}^{d} + {M}_{d f} {i}_{f} + {M}_{d D} {i}_{D} \\ {λ}_{q} = {L}_{q} {i}_{s 2}^{q} + {M}_{q g} {i}_{g} + {M}_{q Q} {i}_{Q}\end{matrix}$$

$${i}_{s 2}^{d}$$

represents the second d-component,

$${i}_{s 2}^{q}$$

represents the second q-component of a second current, R_{d}, R_{q} and R₀ are resistance parameters in a resistance matrix in the Thevenin equation, e_{d}, eq and e₀ are voltage parameters in a voltage-source matrix in the Thevenin equation for the stator, θ₁ represents the first rotor angle, νₐ represents a voltage of an a-phase in the three phase-voltages, ν_{b} represents a voltage of a b-phase in the three phase-voltages, ν_{c} represents a voltage of a c-phase in the three phase-voltages, ν_{d} represents a first voltage on the d-axis among the voltage components, ν_{q} represents a second voltage on the q-axis among the voltage components, ν₀ represents a third voltage on the zero sequence among the voltage components, λ_{d} represents the d-component of the stator magnetic flux linkage, and λ_{q} represents the q-component of the stator magnetic flux linkage. The parameters of the synchronous motor comprises: a direct-axis self-inductance L_{d} of an armature winding, a direct-axis mutual inductance M_{df} between the armature winding and a field winding, a direct-axis mutual-inductance M_{dD} between the armature winding and a direct-axis damping winding D, a quadrature-axis self-inductance L_{q} of the armature winding, a quadrature-axis mutual-inductance M_{qg} between the armature winding and an quadrature-axis damping winding g, a quadrature-axis mutual-inductance M_{qQ} of the armature winding and another quadrature-axis damping winding Q, a field current i_{f}, a current i_{D} of the direct-axis damping winding D, a current i_{g} of the quadrature-axis damping winding g, and a current i_{Q} of the another quadrature-axis damping winding Q. iᵣ represents a rotor current matrix,

$${L}_{ss}^{dq 0}$$

represents a stator self-inductance matrix of the synchronous motor under the dq0 reference frame, Rₛ represents a stator resistance matrix of the synchronous motor, k is equal to 2/Δt,

$${L}_{sr}^{dq 0}$$

represents a stator-rotor mutual-inductance matrix of the synchronous motor under the dq0 reference frame, î_{z} represents a stator current matrix obtained in a immediately previous time step, [symbol] represents a stator voltage matrix obtained in the immediately previous time step, and [symbol] represents a phase domain matrix of a stator magnetic flux linkage obtained in the immediately previous time step.

Details of the modules in the system have been illustrated in steps of the foregoing method embodiments, and hence the details would not be repeated herein for the second embodiment.

### Third Embodiment

A terminal device is further provided according to an embodiment of the present disclosure. The device comprises a processor and a memory.

The memory is configured to store program codes and transmit the program codes to the processor.

The processor is configured to execute instructions in the program codes to perform the foregoing method according to any foregoing embodiment.

The method for modeling electromagnetic transients of a high-efficiency synchronous motor has been described in detail according to the first embodiment of the present disclosure, and hence would not be repeated herein. The processor is configured to execute the steps in the foregoing method embodiments according to instructions in the program codes. Alternatively, the processor when executing a computer program may implement the function of each module/unit in any foregoing system/apparatus embodiments.

As an example, the computer program may be partitioned into one or more modules/units, and the one or more modules/units are stored in the memory and are executed by the processor to implement technical solutions of the present disclosure. The one or more modules/units may refer to a series of instruction segments of a computer program capable of implementing specific functions. The instruction segments are capable of describing a process of executing the computer program in a terminal device.

The terminal device can be a computing device, such as a desktop computer, a laptop, a palmtop, or a cloud server. The terminal device may comprise, but is not limited to, a processor and a memory. Those skilled in the art can understand that the terminal is not limited thereto. In comparison with what is shown in the drawings, the terminal device may comprise more or fewer components, a combination of some components, or different components. For example, the terminal device may further comprise I/O devices, a network access device, a bus, or the like.

The processor may be a central processing unit (CPU), a general-purpose processor, a digital signal processor (DSP), an application specific integrated circuit (ASIC), a field-programmable gate array (FPGA), any other programmable logic device, a discrete gate, a transistor logic device, a discrete hardware component, etc. The general processor may be a microprocessor, a conventional processor, or the like.

The memory may be an internal storage unit of a terminal device, such as a hard disk or a memory of the terminal device. The memory may be an external storage device outside of the terminal device, such as a plug-in hard disk, a smart media card (SMC), a secure digital (SD) card, or a flash card, which is capable of being coupled to the terminal device. Furthermore, the memory may comprise the internal storage unit of the terminal device and the external storage device. The memory is configured to store the computer program and other programs and data required by the terminal device. The memory may further store temporarily data that has been output or is to be output.

For the sake of convenience and brevity of description, a detailed working process of the system, the device, and the units may refer to a corresponding process in the method embodiments and is not repeated herein.

The system, the device, and the method according to embodiments of the present disclosure may be implemented in other manners. For example, the device embodiments described above are only illustrative. For example, the delimitation of the units is on a basis logical functions, and they may be delimited otherwise in practice. For example, multiple units or components may be combined or may be integrated into another system, or some features may be omitted or may be not implemented. In addition, mutual coupling, direct coupling, and communication connection as shown or discussed above may be indirect coupling or communication connection implemented via an interface, an apparatus, or a unit, which may be electrical, mechanical, or in other forms.

The units described as separate components may be or may not be separated physically, and components displayed as units may be or may not be physical units. That is, the components may be located at a same position or may be distributed among multiple network units. Some or all of the units may be selected according to actual requirements to achieve an objective of the present embodiments.

In addition, the functional units in the embodiments of the present disclosure may be integrated into one processing unit or may be units physically independently. Two or more units may be integrated in one unit. The integrated unit may be implemented in a form of hardware, or in a form of a software function unit.

In a case that the integrated unit is implemented as a software function unit and is sold or used as an independent product, it may be stored in a computer readable storage medium. On a basis of such understanding, an essence or a part contributing to the conventional technology of the technical solutions, or all or a part of the technical solutions of the present disclosure, may be embodied in a form of a software product. The software product may be stored in a storage medium and comprise instructions for enabling a computer device (which may be a personal computer, a server, a network device and so on) to perform all or a part of the steps of the methods according to the embodiments of the present disclosure. The storage medium includes a U disk, a removable hard disk, a read-only memory (ROM), a random-access memory (RAM), a magnetic disk, an optical disk, or another media that can store program codes.

As described above, the above embodiments are only intended to describe the technical solutions of the present disclosure, and not to limit the present disclosure. Although the present disclosure is described in detail with reference to the above embodiments, those skilled in the art should understand that, modifications can be made to the technical solutions recorded in the above embodiments, or equivalent replacements can be made to some of the technical features thereof, and the modifications and the replacements will not make the corresponding technical solutions deviate from the spirit and the scope of the technical solutions of the embodiments of the present disclosure.

1. A method for modeling electromagnetic transients of a high-efficiency synchronous motor, comprising:
step S1, predicting a first rotor angular velocity, a first rotor angle, a first quadrature-axis component (q-component) of an armature current, and a first direct-axis component (d-component) of the armature current, of a synchronous motor at a given moment through linear extrapolation;
step S2, determining, according to the first q-component and the first d-component, a first equation of Norton equivalent circuit for simulating the synchronous motor, and transforming the first equation of Norton equivalent circuit expressed in a direct-quadrature-zero (dq0) reference frame into a second equation of Norton equivalent circuit expressed in a three-phase (abc) reference frame through coordinate transformation;
step S3, determining an equivalent conductance matrix, which is an inverse of an equivalent resistance matrix in the second equation of Norton equivalent circuit, and solving a network conductance matrix, through substituting the determined equivalent conductance matrix into the network conductance matrix, to obtain three phase-voltages at ports of the synchronous motor;
step S4, determining, according to the three phase-voltages, a second q-component and a second d-component of the armature current of the synchronous motor, a rotor current of the synchronous motor, and a d-component and a q-component of a stator magnetic flux linkage of the synchronous motor;
step S5, solving a mechanical system equation, through substituting the second q-component, the second d-component, the d-component of the stator magnetic flux linkage, and the q-component of the stator magnetic flux linkage into the mechanical system equation, to obtain a second rotor angular velocity and a second rotor angle of the synchronous motor; and
step S6, obtaining absolute differences between the second q-component and the first q-component, between the second d-component and the first d-component, between the second rotor angular velocity and the first rotor angular velocity, and between the second rotor angle and the first rotor angle, respectively, and returning to the step S1 for a next time step in response to each of the absolute differences being smaller than a respective difference threshold of said absolute difference.

2. The method according to claim 1, further comprising:
returning to the step S4 in response to any of the absolute differences being not smaller than the respective difference threshold of said absolute difference.

3. The method according to claim 1, wherein the mechanical system equation is:
$${T}_{gen} = \frac{p}{2} ( {λ}_{d} {i}_{s 2}^{q} - {λ}_{q} {i}_{s 2}^{d} )$$
$$ω = \frac{d θ}{dt}$$
$$J \frac{d ω}{dt} + D ω = T - {T}_{gen} ,$$
wherein p represents a number of poles in the synchronous motor, λ_{q} represents the q-component of the stator magnetic flux linkage, λ_{d} represents the d-component of the stator magnetic flux linkage,
$${i}_{s 2}^{d}$$
represents the second d-component,
$${i}_{s 2}^{q}$$
represents the second q-component, J represents rotational inertia of the synchronous motor, D represents a coefficient of viscosity and air-damping of the synchronous motor in air, T represents a mechanical torque of the synchronous motor, ω represents the second rotor angular velocity, θ represents the second rotor angle, and t represents time in simulation.

4. The method according to claim 1, wherein determining, according to the first q-component and the first d-component, the first equation of Norton equivalent circuit for simulating the synchronous motor, and transforming the first equation of Norton equivalent circuit expressed in the dq0 reference frame into the second equation of Norton equivalent circuit expressed in the abc reference frame through coordinate transformation, comprises:
obtaining a stator-rotor voltage equation of the synchronous motor, and discretizing the stator-rotor voltage equation through an implicit trapezoidal rule to obtain a first transformation equation;
performing Park transformation on the first transformation equation, eliminating a rotor variable in the first transformation equation, and using average resistance for a direct-axis and a quadrature-axis, to obtain a Thevenin equation for a stator;
transforming the Thevenin equation for the stator to the first equation of Norton equivalent circuit; and
transforming the first equation of Norton equivalent circuit expressed in the dq0 reference frame into the second equation of Norton equivalent circuit expressed in the abc reference frame through phasor coordinate transformation;
wherein the first equation of Norton equivalent circuit is:
$${i}_{d , source} = \frac{{e}_{d , mod}}{{R}_{ave}} {i}_{q , source} = \frac{{e}_{q , mod}}{{R}_{ave}} {i}_{0 , source} = \frac{{e}_{0}}{{R}_{0}} ,$$
$${R}_{ave} = ( {R}_{d} + {R}_{q} ) / 2 ; {e}_{d , mod} = {e}_{d} - \frac{{R}_{d} - {R}_{q}}{2} {i}_{s 1}^{d} ; e = {e}_{q} - \frac{{R}_{d} - {R}_{q}}{2} {i}_{s 1}^{q}$$
wherein the phasor coordinate transformation formula is:
$$[ \begin{matrix}{i}_{a , source} \\ {i}_{b , source} \\ {i}_{c , source}\end{matrix} ] = \frac{\sqrt{2}}{\sqrt{3}} [ \begin{matrix}cos {θ}_{1} & sin {θ}_{1} & \frac{1}{\sqrt{2}} \\ cos ( {θ}_{1} - 120 ° ) & sin ( {θ}_{1} - 120 ° ) & \frac{1}{\sqrt{2}} \\ cos ( {θ}_{1} + 120 ° ) & sin ( {θ}_{1} + 120 ° ) & \frac{1}{\sqrt{2}}\end{matrix} ] [ \begin{matrix}{i}_{d , source} \\ {i}_{q , source} \\ {i}_{0 , source}\end{matrix} ] , and$$
Wherein
$${i}_{s 1}^{d}$$
represents the first d-component,
$${i}_{s 1}^{q}$$
represents the first q-component, R_{d}, R_{q} and R₀ are resistance parameters in a resistance matrix in the Thevenin equation, e_{d}, e_{q} and e₀ are voltage parameters in a voltage-source matrix in the Thevenin equation, i_{d, source} represents a first current of a direct-axis in first equation of Norton equivalent circuit, i_{q, source} represents a second current of a quadrature-axis in the first equation of Norton equivalent circuit, i_{0, source} represents a third current of a zero component in the first equation of Norton equivalent circuit, θ₁ represents a first rotor angle, i_{a, source} represents a first current of an a-phase current source in the second equation of Norton equivalent circuit, i_{b, source} represents a second current of a b-phase current source in the second equation of Norton equivalent circuit, and i_{c, source} represents a third current of a c-phase current source in a second equation of Norton equivalent circuit.

5. The method according to claim 1, wherein determining, according to the three phase-voltages, the second q-component and the second d-component of the armature current of the synchronous motor, the rotor current of the synchronous motor, and the d-component and the q-component of the stator magnetic flux linkage of the synchronous motor, comprises:
performing Park transformation on the three phase-voltages to obtain voltage components of a direct-axis, a quadrature-axis, and a zero sequence;
calculating the second q-component and the second d-component according to matrix parameters of a Thevenin equation for the stator and the voltage components through an armature-current calculation equation;
calculating the rotor current according to parameters of the synchronous motor, the voltage components, the second q-component, and the second d-component through a rotor-current calculation equation;
calculating the d-component and the q-component of the stator magnetic flux linkage according to the parameters of the synchronous motor, the second q-component, the second d-component, and the rotor current, through a stator-flux-linkage-component calculation equation;
wherein the Park transformation is implemented through:
$$[ \begin{matrix}{v}_{d} \\ {v}_{q} \\ {v}_{0}\end{matrix} ] = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ] [ \begin{matrix}{v}_{a} \\ {v}_{b} \\ {v}_{c}\end{matrix} ] ,$$
wherein the armature-current calculation equation is:
$${i}_{s 2}^{d} = ( {e}_{d , mod} - {v}_{d} ) / {R}_{ave} ; {i}_{s 2}^{q} = ( {e}_{q , mod} - {v}_{q} ) / {R}_{ave} ; {i}_{s 2}^{0} = ( {e}_{0} - {v}_{0} ) / {R}_{0} ,$$
$${R}_{ave} = ( {R}_{d} + {R}_{q} ) / 2 ; {e}_{d , mod} = {e}_{d} - \frac{{R}_{d} - {R}_{q}}{2} {i}_{s 1}^{d} ; {e}_{q , mod} = {e}_{q} - \frac{{R}_{d} - {R}_{q}}{2} {i}_{s 1}^{q}$$
wherein the rotor-current calculation equation is:
$${i}_{r} = {R}_{sr}^{dq {0}^{- 1}} ( {P}^{- 1} {h}_{S}^{P D} - {v}_{s}^{dq 0} - {R}_{ss}^{dq 0} {i}_{s}^{dq 0} ) ;$$
$${i}_{r} = {[ \begin{matrix}{i}_{f} & {i}_{D} & {i}_{g} & {i}_{Q}\end{matrix} ]}^{T}$$
$${v}_{s}^{dq 0} = {[ \begin{matrix}{v}_{d} & {v}_{q} & {v}_{0}\end{matrix} ]}^{T}$$
$${i}_{s}^{dq 0} = {[ \begin{matrix}{i}_{s 2}^{d} & {i}_{s 2}^{q} & {i}_{0}\end{matrix} ]}^{T}$$
$${h}_{s}^{PD} = - {R}_{s} {\hat{i}}_{s} + k {\hat{λ}}_{s} - {\hat{v}}_{s}$$
$$P = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ]$$
$${R}_{ss}^{dq 0} = {R}_{s} + {kL}_{ss}^{dq 0} ; {R}_{sr}^{dq 0} = {kL}_{sr}^{dq 0} ,$$
wherein the stator-flux-linkage-component calculation equation is:
$${λ}_{d} = {L}_{d} {i}_{s 2}^{d} + {M}_{df} {i}_{f} + {M}_{dD} {i}_{D} ,$$
$${λ}_{q} = {L}_{q} {i}_{s 2}^{q} + {M}_{qg} {i}_{g} + {M}_{qQ} {i}_{Q}$$
wherein
$${i}_{s 2}^{d}$$
represents the second d-component
$${i}_{s 2}^{q}$$
represents the second q-component of a second current, R_{d}, R_{q} and R₀ are resistance parameters in a resistance matrix in the Thevenin equation, e_{d}, eq and e₀ are voltage parameters in a voltage-source matrix in the Thevenin equation for the stator, θ₁ represents the first rotor angle, νₐ represents a voltage of an a-phase in the three phase-voltages, ν_{b} represents a voltage of a b-phase in the three phase-voltages, ν_{c} represents a voltage of a c-phase in the three phase-voltages, ν_{d} represents a first voltage on the d-axis among the voltage components, ν_{q} represents a second voltage on the q-axis among the voltage components, ν₀ represents a third voltage on the zero sequence among the voltage components, λ_{d} represents the d-component of the stator magnetic flux linkage, and λ_{q} represents the q-component of the stator magnetic flux linkage;
wherein the parameters of the synchronous motor comprises: a direct-axis self-inductance L_{d} of an armature winding, a direct-axis mutual inductance M_{df} between the armature winding and a field winding, a direct-axis mutual-inductance M_{dD} between the armature winding and a direct-axis damping winding D, a quadrature-axis self-inductance L_{q} of the armature winding, a quadrature-axis mutual-inductance M_{qg} between the armature winding and an quadrature-axis damping winding g, a quadrature-axis mutual-inductance M_{qQ} of the armature winding and another quadrature-axis damping winding Q, a field current i_{f}, a current i_{D} of the direct-axis damping winding D, a current i_{g} of the quadrature-axis damping winding g, and a current i_{Q} of the another quadrature-axis damping winding Q; and
wherein iᵣ represents a rotor current matrix,
$${L}_{s s}^{d q 0}$$
represents a stator self-inductance matrix of the synchronous motor under the dq0 reference frame, Rₛ represents a stator resistance matrix of the synchronous motor, k is equal to 2/Δt,
$${L}_{s r}^{d q 0}$$
represents a stator-rotor mutual-inductance matrix of the synchronous motor under the dq0 reference frame, i_{z} represents a stator current matrix obtained in a immediately previous time step, [symbol] represents a stator voltage matrix obtained in the immediately previous time step, and [symbol] represents a phase domain matrix of a stator magnetic flux linkage obtained in the immediately previous time step.

6. The method according to claim 1, wherein determining the equivalent conductance matrix, which is the inverse of the equivalent resistance matrix in the second equation of Norton equivalent circuit, and solving the network conductance matrix, through substituting the determined equivalent conductance matrix into the network conductance matrix, to obtain the three phase-voltages at the ports of the synchronous motor, comprises:
calculating the inverse of the equivalent resistance matrix in the second equation of Norton equivalent circuit to obtain the equivalent conductance matrix;
inputting, before the next time step, the obtained equivalent conductance matrix into the network conductance matrix; and
solving the network conductance matrix through a network solving equation to obtain the three phase-voltages;
wherein the network solving equation is YV=1, Y represents the network conductance matrix, I represents a current matrix comprising current parameters in the second equation of Norton equivalent circuit, and V represents a voltage matrix comprising the three phase-voltages.

7. A system for modeling electromagnetic transients of a high-efficiency synchronous motor, comprising:
a predicting module, configured to predict a first rotor angular velocity, a first rotor angle, a first quadrature-axis component (q-component) of an armature current, and a first direct-axis component (d-component) of the armature current, of a synchronous motor at a given moment through linear extrapolation;
a first processing module, configured to determine, according to the first q-component and the first d-component, a first equation of Norton equivalent circuit for simulating the synchronous motor, and transform the first equation of Norton equivalent circuit expressed in a direct-quadrature-zero (dq0) reference frame into a second equation of Norton equivalent circuit expressed in a three-phase (abc) reference frame through coordinate transformation;
a first calculating module, configured to determine an equivalent conductance matrix, which is an inverse of an equivalent resistance matrix in the second equation of Norton equivalent circuit, and solve a network conductance matrix, through substituting the determined equivalent conductance matrix into the network conductance matrix, to obtain three phase-voltages at ports of the synchronous motor;
a second processing module, configured to determine, according to the three phase-voltages, a second q-component and a second d-component of the armature current of the synchronous motor, a rotor current of the synchronous motor, and a d-component and a q-component of a stator magnetic flux linkage of the synchronous motor;
a second calculating module, configured to solve a mechanical system equation, through substituting the second q-component, the second d-component, the d-component of the stator magnetic flux linkage, and the q-component of the stator magnetic flux linkage into the mechanical system equation, to obtain a second rotor angular velocity and a second rotor angle of the synchronous motor; and
a determining module, configured to obtain absolute differences between the second q-component and the first q-component, between the second d-component and the first d-component, between the second rotor angular velocity and the first rotor angular velocity, and between the second rotor angle and the first rotor angle, respectively, and output the second rotor angular velocity and the second rotor angle in response to each of the absolute differences being smaller than a respective difference threshold of said absolute difference.

8. The system according to claim 7, wherein the mechanical system equation is:
$$\begin{matrix}{T}_{g e n} = \frac{p}{2} ( {λ}_{d} {i}_{s 2}^{q} - {λ}_{q} {i}_{s 2}^{d} ) \\ ω = \frac{d θ}{dt} \\ J \frac{d ω}{d t} + D ω = T - {T}_{g e n}\end{matrix} ,$$
wherein p represents a number of poles in the synchronous motor, λ_{q} represents the q-component of the stator magnetic flux linkage, λ_{d} represents the d-component of the stator magnetic flux linkage,
$${i}_{s 2}^{d}$$
represents the second d-component,
$${i}_{s 2}^{q}$$
represents the second q-component, J represents rotational inertia of the synchronous motor, D represents a coefficient of viscosity and air-damping of the synchronous motor in air, T represents a mechanical torque of the synchronous motor, ω represents the second rotor angular velocity, θ represents the second rotor angle, and t represents time in simulation.

9. The system according to claim 7, wherein the second processing module comprises a transforming sub-module, a first calculating sub-module, a second calculating sub-module, and a third calculating sub-module;
the transforming sub-module is configured to perform Park transformation on the three phase-voltages to obtain voltage components of a direct-axis, a quadrature-axis, and a zero sequence;
the first calculating sub-module is configured to calculate the second q-component and the second d-component according to matrix parameters of a Thevenin equation for the stator and the voltage components through an armature-current calculation equation;
the second calculating sub-module is configured to calculate the rotor current according to parameters of the synchronous motor, the voltage components, the second q-component, and the second d-component through a rotor-current calculation equation; and
the third calculating sub-module is configured to calculate the d-component and the q-component of the stator magnetic flux linkage according to the parameters of the synchronous motor, the second q-component, the second d-component, and the rotor current, through a stator-flux-linkage-component calculation equation;
wherein the Park transformation is implemented through:
$$[ \begin{matrix}{v}_{d} \\ {v}_{q} \\ {v}_{0}\end{matrix} ] = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ] [ \begin{matrix}{v}_{a} \\ {v}_{b} \\ {v}_{c}\end{matrix} ] ,$$
wherein the armature-current calculation equation is:
$${i}_{s 2}^{d} = ( {e}_{d , m o d} - {v}_{d} ) / {R}_{a v e} ; {i}_{s 2}^{q} = ( {e}_{q , m o d} - {v}_{q} ) / {R}_{a v e} ; {i}_{s 2}^{0} = ( {e}_{0} - {v}_{0} ) / {R}_{0}$$
$${R}_{a v e} = ( {R}_{d} + {R}_{q} ) / 2 ; {e}_{d , m o d} = {e}_{d} - \frac{{R}_{d} - {R}_{q}}{2} {i}_{s 1}^{d} ; {e}_{q , m o d} = {e}_{q} - \frac{{R}_{d} - {R}_{q}}{2} {i}_{s 1}^{q} ,$$
wherein the rotor-current calculation equation is:
$$\begin{matrix}{i}_{r} = {R}_{s r}^{d q {0}^{- 1}} ( {P}^{- 1} {h}_{s}^{P D} - {v}_{s}^{d q 0} - {R}_{s s}^{d q 0} {i}_{s}^{d q 0} ) ; \\ {{i}_{r} [ \begin{matrix}{i}_{f} & {i}_{D} & {i}_{g} & {i}_{Q}\end{matrix} ]}^{T} \\ {v}_{s}^{d q 0} = {[ \begin{matrix}{v}_{d} & {v}_{q} & {v}_{0}\end{matrix} ]}^{T} \\ {i}_{s}^{d q 0} = {[ \begin{matrix}{i}_{s}^{d q 0} & {i}_{s 2}^{q} & {i}_{0}\end{matrix} ]}^{T} \\ {h}_{s}^{PD} = - {R}_{s} {\hat{i}}_{s} + k {\hat{λ}}_{s} - {\hat{v}}_{s} \\ P = \frac{\sqrt{2}}{\sqrt{3}} [ \begin{matrix}cos {θ}_{1} & cos ( {θ}_{1} - 120 ° ) & cos ( {θ}_{1} + 120 ° ) \\ sin {θ}_{1} & sin ( {θ}_{1} - 120 ° ) & sin ( {θ}_{1} + 120 ° ) \\ \frac{1}{\sqrt{2}} & \frac{1}{\sqrt{2}} & \frac{1}{\sqrt{2}}\end{matrix} ] \\ {R}_{ss}^{dq 0} = {R}_{s} + {kL}_{ss}^{dq 0} ; {R}_{sr}^{dq 0} = {kL}_{sr}^{dq 0} ,\end{matrix}$$
wherein the stator-flux-linkage-component calculation equation is:
$$\begin{matrix}{λ}_{d} = {L}_{d} {i}_{s 2}^{d} + {M}_{df} {i}_{f} + {M}_{dD} {i}_{D} \\ {λ}_{q} = {L}_{q} {i}_{s 2}^{q} + {M}_{qg} {i}_{g} + {M}_{qQ} {i}_{Q}\end{matrix} ,$$
wherein
$${i}_{s 2}^{d}$$
represents the second d-component,
$${i}_{s 2}^{q}$$
represents the second q-component of a second current, R_{d}, R_{q} and R₀ are resistance parameters in a resistance matrix in the Thevenin equation, e_{d}, eq and e₀ are voltage parameters in a voltage-source matrix in the Thevenin equation for the stator, θ₁ represents the first rotor angle, νₐ represents a voltage of an a-phase in the three phase-voltages, ν_{b} represents a voltage of a b-phase in the three phase-voltages, ν_{c} represents a voltage of a c-phase in the three phase-voltages, ν_{d} represents a first voltage on the d-axis among the voltage components, ν_{q} represents a second voltage on the q-axis among the voltage components, ν₀ represents a third voltage on the zero sequence among the voltage components, λ_{d} represents the d-component of the stator magnetic flux linkage, and λ_{q} represents the q-component of the stator magnetic flux linkage;
wherein the parameters of the synchronous motor comprises: a direct-axis self-inductance L_{d} of an armature winding, a direct-axis mutual inductance M_{df} between the armature winding and a field winding, a direct-axis mutual-inductance M_{dD} between the armature winding and a direct-axis damping winding D, a quadrature-axis self-inductance L_{q} of the armature winding, a quadrature-axis mutual-inductance M_{qg} between the armature winding and an quadrature-axis damping winding g, a quadrature-axis mutual-inductance M_{qQ} of the armature winding and another quadrature-axis damping winding Q, a field current i_{f}, a current i_{D} of the direct-axis damping winding D, a current i_{g} of the quadrature-axis damping winding g, and a current i_{Q} of the another quadrature-axis damping winding Q; and
wherein iᵣ represents a rotor current matrix,
$${L}_{s s}^{d q 0}$$
represents a stator seir-inductance matrix of the synchronous motor under the dq0 reference frame, Rₛ represents a stator resistance matrix of the synchronous motor, k is equal to 2/Δt,
$${L}_{s r}^{d q 0}$$
represents a stator-rotor mutual-inductance matrix of the synchronous motor under the dq0 reference frame, i_{z} represents a stator current matrix obtained in a immediately previous time step, [symbol] represents a stator voltage matrix obtained in the immediately previous time step, and [symbol] represents a phase domain matrix of a stator magnetic flux linkage obtained in the immediately previous time step.

10. A terminal device, comprising a processor and a memory, wherein:
the memory is configured to store program codes and transmit the program codes to the processor, and
the processor is configured to execute instructions in the program codes to perform the method according to claim 1.

11. A non-transitory computer-readable storage medium, storing program codes, wherein the program codes when executed by a processor implements the method according to claim 1.

12. A method for fabricating a high-efficiency synchronous motor, comprising:
obtaining original parameters for fabricating a synchronous motor;
establishing a model simulating the synchronous motor through the method according to claim 1;
adjusting the original parameters according to operation of the simulated synchronous motor in the model to obtain adjusted parameters; and
fabricating the synchronous motor according to the adjusted parameters.
